(19) United States
(12) Patent Application Publication
(10) Pub. No.: US 2017/0308981 A1
(43) Pub. Date: Oct. 26, 2017

(54) PATIENT CONDITION IDENTIFICATION AND TREATMENT

(71) Applicants: Narges Sharif Razavian, New York, NY (US); Saul Blecker, New York, NY (US); Ann Marie Schmidt, New York, NY (US); Aaron Smith-McLallen, Upper Darby, PA (US); Somesh Nigam, Philadelphia, PA (US); David Sontag, New York, NY (US)

(72) Inventors: Narges Sharif Razavian, New York, NY (US); Saul Blecker, New York, NY (US); Ann Marie Schmidt, New York, NY (US); Aaron Smith-McLallen, Upper Darby, PA (US); Somesh Nigam, Philadelphia, PA (US); David Sontag, New York, NY (US)

(73) Assignees: NEW YORK UNIVERSITY, New York, NY (US); INDEPENDENCE BLUE CROSS, Philadelphia, PA (US)

(21) Appl. No.: 15/494,354

(22) Filed: Apr. 21, 2017

Related U.S. Application Data
(60) Provisional application No. 62/326,587, filed on Apr. 22, 2016.

(51) Int. Cl. G06Q 50/22; G06Q 10/10; G06F 19/00; G06Q 50/24; G06Q 40/08

(52) U.S. Cl. CPC G06Q 50/22; G06Q 50/24; G06Q 40/08; G06F 19/32; G06F 19/322; G06Q 10/10

(57) ABSTRACT

In one embodiment, computer implemented method identifies a risk of developing a condition for a particular patient. First, an initial variable set is developed by utilizing one or more patient databases. Second, an enhanced model predictive of a selected condition is created using machine learning. With the enhanced model developed, patient features vectors are created from a patient health information database for the initial variable set. The enhanced model is applied to these patient feature vectors to predict development of the condition. Patients predicted to have the condition can be enrolled in an appropriate intervention program.

### CROSS-REFERENCE TO RELATED APPLICATIONS

This application claims the benefit of priority to U.S. Patent Application No. 62/326,587 filed on Apr. 22, 2016, the entire content of which is incorporated herein by reference.

### BACKGROUND OF THE INVENTION

Despite the success of lifestyle-based interventions for reducing the likelihood of developing diabetes and for reducing the likelihood of developing complicating conditions among those with diabetic disease, successfully implementing these programs is not yet feasible on a national scale. Developing and disseminating large scale interventions is resource-intensive both in terms of identifying eligible candidates and in the delivery of the intervention itself. Interventions are costly and can only achieve cost-effectiveness when the right population, those with high risk, can be identified efficiently, and when intervention science can create a broader range of effective strategies to reduce the likelihood of disease onset.

Although intervention programs exist for a numerous disease states efficient identification of candidates for these programs hinders both the development and implementation of large scale programs that could potentially have an impact on a population basis. For illustrative purposes, diabetes is the focus of examples herein. Nearly 30 million Americans have been diagnosed with diabetes or have latent, undiagnosed Type 2 (adult onset) diabetes. Type 2 diabetes is an increasingly prevalent chronic condition worldwide and the total number of people with diabetes is estimated to rise from 171 million in 2000 to about 366 million in 2030. Without appropriate treatment, this condition leads to significant complications such as cardiovascular disease, kidney disease, stroke, nerve damage, blindness, and amputations. Early detection and intervention is essential for reducing the prevalence and long-term complications of diabetes in the population. And for those with existing diabetic disease the early intervention can prevent the onset of complicating conditions.

Several large studies have demonstrated that lifestyle changes are effective at lowering the risk of Type 2 diabetes. For example, the Centers for Disease Control (CDC) Diabetes Prevention Program (DPP) showed that intensive lifestyle intervention focusing on exercise and weight loss was more effective at lowering the risk of Type 2 diabetes than medication with Metformin. Similar studies in Finland, China, India, Japan, and Germany confirmed the benefits of intense lifestyle improvement for delaying onset of Type 2 diabetes. In the DPP program, for instance, the participants were selected based on obesity and elevated glucose values. These inclusion criteria had a positive predictive value of only 11%. In other words, only 11% of the participants who met the inclusion criteria, but did not receive lifestyle or Metformin interventions, developed diabetes within 3 years. (See, Reduction in the Incidence of Type 2 Diabetes with Lifestyle Intervention or Metformin. New England Journal of Medicine. 2002; 346(6):393-403.) Existing models for diabetes risk assessment, such as the ARIC enhanced model, San Antonio model, AUSDRISK and FINDRISC, were designed to assess diabetes risk using questionnaires. Although the studies involve tens of thousands of people, the scale of many health problems is multiple millions of individuals at risk, thus current systems are ill-equipped to address large scale health problems.

Although there are many identification models that use a questionnaire approach, other analytic approaches do exist. The broad adoption of electronic health records and administrative data provides a unique opportunity to perform population-level risk stratification for diseases. These models are parsimonious, using a small number of variables that are expected to be always observed, such as age, weight and body mass index, ethnicity, elevated glucose, diet, exercise, smoking, family history of diabetes, and laboratory values such as uric acid and cholesterol. However, all of these known models and methods, as demonstrated in studies, suffer from the same limitation, which is that the data available for a population-level analysis will invariably have many of these variables' values missing or incorrect, thereby significantly diminishing the models' utility.

Current computer-assisted disease risk identification models are improvements over paper-bases assessment approaches, however to date there are no known approaches that leverage state-of-the-art big data machine learning techniques. In recent years three factors have converged that allow disease risk identification to significantly outperform existing approaches both in terms of predictive accuracy and scale. Specifically, the availability of data, technology for housing, manipulating, and analyzing billions of data elements efficiently, and methodologies for extracting information from these large data stores. Machine learning techniques have the ability to discover relevant features and combinations of features that predict disease risk in ways that less sophisticated approaches cannot. For example, these models are also able to account for the sequencing of events in the patients' medical history in complex ways that greatly aid in the prediction of disease risk.

### SUMMARY OF THE INVENTION

One embodiment relates to a computer-implemented machine for identifying a risk of developing a condition comprising a processor and a tangible computer-readable medium operatively connected to the processor. The tangible computer readable medium includes computer code configured to: analyze a patient health information database; applying a machine learning algorithm using the database to develop a prediction model for the condition; applying surrogates identified to address missing or incorrect data; identify a risk for the patient to develop the condition; and identify a course of preventative treatment based on the identified risk.

Another embodiment relates to a method for identifying a risk of developing a condition. A database having a plurality of information for a plurality of patients is analyzed. A machine learning algorithm is applied using the database to develop a prediction model for the condition. One or more surrogates are identified for predictive variables in the predication model. One or more preventative treatments associated with the condition are identified.

Another embodiments relates to a method for assessing the risk of developing a condition. A patient data file is prepared containing a plurality of information about the patient. A predication model is applied based upon an insurance claim database. One or more surrogates identified by the prediction model to address missing or incorrect data in the patient data file are applied. A course of preventative treatment based on the identified risk is identified.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 shows a framework for a prediction task. In FIG. 1, features are derived from patient data up to time T. Outcome is evaluated in the two-year follow-up window after a gap of size W. Patients who have diabetes before T+W, or have insufficient enrollment, are excluded during training and evaluation (denoted as *). Patient outcome is positive (denoted as +) if diabetes onset happens in the outcome evaluation period, and negative (denoted as −) otherwise.

FIG. 2 illustrates the design for the example case study regarding type 2 diabetes.

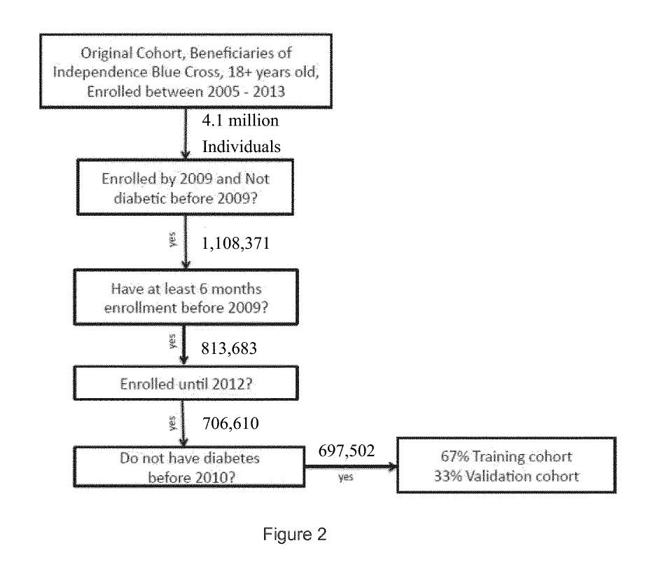

FIG. 3 illustrates a generalization of phase one and phase two of a method described herein. Claims data are analyzed using a machine learning algorithm to discover predictive variables and surrogates. An intervention is implemented for a population based upon the predicted risk for a disease. The impact can be measured, the cost/benefit analyzed. The impact of the intervention on future claims data can be analyzed, and the results are fed back into the learning algorithm for ongoing optimization.

FIG. 4 illustrates a computer system for use with certain implementations.

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION OF THE PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

“Enhanced Model” as used herein refers to a prediction model that has been optimized with a L1 regularized loss function. The prediction model can be a logistic regression model.

“L1” as used herein refers to L1 regularization of regression coefficients. L1 regularization gives sparse estimates. Thus, in large data sets L1 regularization achieves computational savings by not computing for those variables that have a coefficient of zero.

“Condition” or “Disease” refers to a condition state of an individual including medical conditions, medical disorders, and injuries. Medical conditions include diseases, such as Type 2 diabetes used as an illustrative condition herein.

“Variable” as used herein refers to an attribute that varies between individuals and may vary within individuals over time. Each individual will have a certain value for the variable, the value may be a number or a classification such as “obese”. The values for a given variable may be binary, such as the presence or absence of a certain genetic marker or may be continuous, such as age.

“Variable set” refers to the group of variables used in a model.

“Patient data” refers to information regarding an individual. The information may include personal information such as age and ethnicity, socio-economic information such as income, and medical information such as information corresponding to International Classification of Diseases diagnosis codes. Each item of patient data may correspond to a variable.

“Morbidity” as used herein refers to the state where an individual has a condition, for example a diseased state such as having Type 2 diabetes.

“Morbidity Rate” as used herein is the incidence rate or prevalence of a particular condition.

“Initial variable set” is the set of patient data gathered for a given population. The initial variable set used for illustrative purposes herein contained ˜42,000 variables.

“Disease variable set” is a subset of the initial variable set that is considered predictive of the disease. For illustrative purposes, the diabetes variable set is used herein.

“Predictive variable” as used herein is a variable that is a known risk factor or determinate associated with a selected condition. The predictive variable is correlational but may not be causal with respect to the condition.

“Surrogate variable” as used herein is a predictive variable which gives an estimate of other variables that would typically be included in a predictive model but that are not observed in the patient data.

The methods and systems described herein overcome the disadvantages of questionnaire approaches and other less sophisticated computer-aided approaches by: (i) being able to use the most state-of-the-art technologies applied to vast amounts of readily available data including, but not limited to administrative medical and pharmacy claims, and lab test results; (ii) taking advantage of the full breadth of a patient's health data; (iii) appropriately weighting each parameter or feature; (iv) being computationally efficient, capable of integrating any new patient information and producing an updated risk score (prediction of occurrence/absence of the condition) within seconds; (v) having higher positive predictive value than questionnaire-based screening tools, and; (vi) providing opportunities to develop an entirely new set of large-scale, targeted interventions. See, Razavian Narges, Blecker Saul, Schmidt Ann Marie, Smith-McLallen Aaron, Nigam Somesh, and Sontag David. Big Data. January 2016, 3(4): 277-287. doi:10.1089/big.2015.0020 and Supplementary Data for same, incorporated herein by reference.

The present application describes, in one embodiment, systems and methods for accurately predicting who may develop a specific medical condition to enable appropriate remedial measures to prevent the onset of diseases such as Type II diabetes. Some embodiments would reduce healthcare costs and improve lives of the affected individuals and their families. The method includes utilizing machine learning with a dataset, which may be “Big Data,” to develop a predictive model for a condition or set of conditions. The methods described herein enable rapid prediction assessment for millions of patients with potentially incomplete information, i.e. missing or incomplete predictive variables in the initial data set, without the need to correct for missing data individually.

In one embodiment, the methods and systems can be divided into four phases. Phase one relates to identification and creation of an initial variable (feature) set. Phase two relates to the development of an enhanced model predicting a condition in individuals using machine learning and a training dataset, such as an insurance database with confirmed diagnoses for a condition, to identify predictive variables and surrogate variables for the condition within the initial variable set. Phase three involves the development of a feature vector for a patient, or more generally feature vectors for a large cohort of patients and application of the enhanced model to the cohort's feature vectors to predict individuals who will develop the condition. Phase four relates to implementation of an intervention program for patients predicted as developing the condition.

In phase one, an initial variable (or feature) set is created. The initial variable set may be created from a single database or may be a composite of numerous sources. Some embodiments can be applied to a wide range of available patient databases that may exist in other forms. For example, data from different payors including government entities, or other service providers such as hospitals and health systems. Any database containing medical data such as diagnosis codes, procedures performed, health care utilization information, medications, and laboratory test results could be used to appropriately train the risk prediction model described herein These databases have a plurality of information for a plurality of patients. The variables need not be selected for known predictive value to a particular condition. The initial variable set may be selected and curated for use with a multitude of different conditions, providing a flexible method of prediction the occurrence of numerous conditions. For example, a healthcare database with millions of users' data may be used, in the examples provided herein a set of 42,000 variables were selected from among variables available in an insurance database.

In one embodiment, phase one includes building an initial variable set using beneficiary demographics, all past and current medical conditions, procedures, physician specialty visits, laboratory orders and results, and medication utilization in the insurance database. It should be appreciated that the variable set described herein in the example study was tailored based on the data in the associated insurance database and utilize common medical condition coding such as International Classification of Diseases, Current Procedure Terminology, and ICD-9 Procedural codes, each grouped by Clinical Classification Software (CCS). The described methods and system could utilize additional or different data where associated with a different insurance database or a different type of database altogether. Additional variables may include physician specialty from a clinical encounter, and medications, for example using the National Drug Code (NDC) and grouped by therapeutic class codes. Further, patient lab measurement records may be based upon established systems such as the Logical Observation Identifiers Names and Codes (LOINC) numbers. Further, the possible response for each indicator may be relative or absolute, for example binary (performed/not performed) or low, high, or normal. Further, temporal aspects may be incorporated, such as several prior clinical test results weighted based on elapsed time. If a variable was not observed its correlation (coefficient) may be set to 0 rather than imputed.

It has been found that the use of additional variables has the benefit of allowing for identification and use of surrogate variables for missing data. While the number of variables used can be minimized, such as in the enhanced model used in the study, this result of fewer more predictive variables is contrary to the goal of providing surrogates applicable to a large data set. In the example of an insurance company database, individual patients may exhibit different missing data from among a hundred or more variables, necessitating the need for a wide range of surrogates to address the variance in missing data.

In phase two, with an initial variable set created, a model for prediction can be created. Phase two provides for use of machine learning to fit models predicting the onset of a condition to develop an enhanced model which provides for enhanced prediction of the particular condition, such as type II diabetes. In one embodiment, machine learning is utilized to identify coefficients corresponding to predictive weighting for the initial variable set, to select a subset of predictive variables and surrogate variables for use in an enhanced model for predicting occurrence of a condition. While the initial variable set may be created without specificity for a particular condition, in one embodiment this second phase develops an enhanced model for predictive of a particular condition. In one embodiment, machine learning identifies a subset of the initial variable set and a weight vector for those variables as predictors (for the condition of interest). That subset of variables may be determined through training of a machine learning device, such as using a dataset comprising the initial set of variables and confirmed medical diagnosis of the condition. The enhanced model may be improved through one or more rounds of training using the dataset to develop a feature set for the enhanced model comprising predicative variables and surrogate variables. Thus, machine learning algorithm is utilized with the database to develop an enhanced model with a feature set comprising a subset of the initial set of variables identified in phase one.

There is a theoretical relationship between the number of variables that are included in a model, i.e. the subset of variables, and the number of positive examples that are required to statistically learn the model. It has previously been shown that the logistic regression will converge when the number of positive examples and number of features are in the same ‘order of magnitude’. i.e. (positive cases)˜O(number of variables). (See, NG, A., 2002). On discriminative vs. generative classifiers; A comparison of logistic regression and naive bayes. Advances in NIPS 14; Ng, Andrew Y. “Feature selection, L 1 vs. L 2 regularization, and rotational invariance.” Proceedings of the twenty-first international conference on Machine learning. ACM, 2004.) With L1 regularization, (as used in certain embodiments), the sample complexity grows logarithmically in the number of irrelevant features, and polynomial in the number of relevant features. Based on analysis usually between ˜100 to ˜1000 can be expected to be ‘relevant’ features for a given disease therefore an initial variable set would need a few thousand ‘positive cases’ to have a reasonable model. More than that, it can only improve the quality of the model estimation.

Current systems and methods utilize these disease variable sets but lack a mechanism for addressing missing or incomplete data. This is problematic for several reasons. First, as the population being considered increases in size, the number of variables missing for at least one patient as well as the total number of missing variables is likely to increase. Second, the issue can be heightened when considering some conditions that have a correlation with poor access or utilization of medical professionals, as the occurrence of missing or incomplete data for variables included in the disease variable set is increased in the very subgroup most likely to be at higher risk for the condition. Thus, accurately and quickly predicting a disease condition for individuals in a large population is not possible with current systems.

One embodiment provides for an enhanced model that addresses the need for relevant features or variables while also addressing the issues that can arise from missing data in patient records by utilizing machine learning and big data to discover surrogate variables for predictive variables that would otherwise be missing or incorrect. For example, a method for identifying patients for treatment of diabetes would include as part of the risk assessment whether the individual is obese. As obesity is a known risk factor for type 2 diabetes, one or more variables related to obesity would be considered predictive variables and included in the disease variable set. Thus, an example of missing information would that the patient's data file lacks information regarding whether the patient is obese (for example, using the ICD9 diagnosis code for obesity). Thus, surrogate variables, such as blood pressure, level of physical exercise, which correlate with the predictive variable, can be included in the disease variable set.

As an example, obesity is a predictive variable in many well-known diabetes prediction models. However, in the medical records, obesity is not often recorded. Therefore, a predicative system that only can work with obesity will be missing this information in assessment of diabetes risk in large populations. Furthermore, questionnaire based information gathering also suffers from patients not reporting their obesity status honestly or correctly. However, there are several other variables that also are observed alongside obesity in individuals and which do not have these issues. These can be considered surrogate variables to the predictive obesity variable.

In one aspect of the presently described method, these surrogate variables are automatically discovered. Example surrogates for obesity would be sleep apnea, and esophageal reflux. These two variables are more recorded than ‘obesity’, easier to collect in questionnaires as well as more likely to be answered honestly than questions related directly to obesity itself. In the medical records these data elements are captured more frequently.

In traditional methods, it is not clear how the model would discover and use these surrogates automatically from the data. The method and systems described herein concurrently discovers these surrogates and learns the appropriate weights for them, for assessing future diabetes risk.

Often these surrogate variables provide additional predictive power to the learning algorithm. For instance, even after adjusting for obesity among patients whom we have already observed to be obese, research has shown that both sleep apnea and esophageal reflux have additional positive association (conditional odds ratio statistically significantly above 1). This indicates that the additional variables (surrogate or non-surrogates) all have the potential to have causal effects on the disease onset, and the present systems and methods are capable of recovering them.

Specifically, the enhanced model may be developed using machine learning with regression models. In one embodiment, sparse, or L1-regularized, logistic regression is utilized. This method provides a computationally efficient alternative to commonly used variable selection methods such as forward selection and backward elimination, and eliminates both variable ordering bias and the need to adjust for the p-value inflation coming from multiple comparison tests on the same dataset. L1-regularization simultaneously searches over all variables, initially using the entire initial variable set, and leverages strong mathematical principles to recover the true set of predictors and learn the corresponding beta coefficients, even when the number of samples is smaller than the number of irrelevant variables. However, other methods of machine learning may also be used so long as those methods control for over fitting. Examples of machine learning models that can be used include support vector machines, random forests, neural networks, and decision trees.

L1-regularization works by adding a penalty to the classification loss. This penalty is the sum of absolute values of the coefficients (called L1 penalty) and has a specific property: It guides the optimization algorithm to select a beta-coefficient vector that pushes very low weights to zero when those low weights do not improve the accuracy of the prediction. As a result, the final beta coefficient vectors will be sparse, interpretable, robust-to-noise, and statistically powerful. Fast algorithms to optimize the accuracy of such models are available. One of skill in the art will appreciate that in one embodiment any convex optimization method can be used. For this study, an algorithm based on Dual Coordinate Descent was used, which handles massive datasets very efficiently, to train these models from data. In one embodiment, the data set is validated, for example using fold-based cross validation.

For comparative purposes, a parsimonious model using variables known to predict for the disease may be used as a baseline for comparison of the enhanced model for training the system by application of machine learning using a large patient database to identify surrogate variables and develop feature set. For example, a patient health information database, such as that from an insurance company containing health-related claims and other information, is accessed and analyzed.

In phase three, with the enhanced model developed, new patients can be stratified by building their feature vector (such as using an insurance database) and applying the enhanced model to their feature vector. Initially, a feature vector for a patient or feature vectors for a cohort of patients are created, such as using an insurance database. Construction of the patient feature vector may utilize determination of the value for each variable in the initial variable set. Note that a relatively small subset of these variables will be non-zero for each person, and only a few of them are important for predicting risk of each condition.

Since the enhanced model can be developed for numerous different conditions, in one embodiment, the feature vector is general and applicable to all disease onsets, during this third phase all the variables are constructed from the patient data file to provide a feature vector that can be used with enhanced models tailored to numerous conditions. As the data come from an electronic database, the feature construction step for each patient takes only a fraction of a second. The enhanced model, is then applied to patient feature vector.

Next, the enhanced model is applied to a feature vector for a patient (notably, it can be applied to a large cohort) to predict development of a condition. The prediction may be for development of the condition over a particular time period, such as within 1, 2, or 3 years. One embodiment relates to a method of applying the enhanced model to predict development of the condition. Phase three provides for the application of the enhanced model to a particular patient population using the feature vectors and addressing missing or incomplete predictive variables with surrogate variables, to identify the risk for each patient within that population. A patient data file having health information regarding the patient is accessed. This database may have information that is missing or incorrect. The trained system is able to identify typically incorrect information and ignore that information or address missing information by utilizing other information. Further, the use of redundant predictors for given predictive model allows for amplification of “good” signals in an otherwise noisy data set. The predictive model is applied using information from the patient data file to identify the risk associated with developing the condition. Missing or incorrect data in the patient data file is addressed based upon the model developed using the machine learning.

In another embodiment, in phase four, the predictions from the enhanced model as applied to the cohort is utilized for preventive treatment for the condition A course of preventative treatment is identified based upon application of the predictive model to a particular patient. In one embodiment, the performance of the system is adequate with only a few hundred variables considered. In one implementation, the learning portion of the method is performed for each separate database to generate predicted probabilities of a condition state. The generated predicted probabilities can further be utilized to segment the population for appropriate treatment/intervention. For example, the learning algorithm step as described herein would be performed at each insurance company using their in-house data.

The ability to perform early detection of a condition, such as Type 2 diabetes, from administrative data would enable the implementation of population-level interventions. Further, methods of the present invention allow identification of the relative importance of different risk factors in terms of how early they may predict onset of a condition, Type 2 diabetes in the example below. Observational assessment using clinical and health care utilization data provides a window into the lives of patients prior to a clinical diagnosis of the condition and at a scale much larger than what would be feasible within the scope of a clinical trial or prospective cohort study. Interventions, particularly at the population level, may be developed considering the results of the application of the predictive model for multiple conditions. Thus, the risk for a population, such as a set of employees at a company, may be addressed for multiple conditions (such as diabetes, heart disease, and stroke) through a single intervention program.

As mentioned above, in one embodiment, a course of preventative treatment or an intervention is identified based upon application of the predictive model to a particular patient (or a cohort of patients). For example, an insurance company can utilize insurance data to train the system and/or apply the model to insurance data to identify at-risk individuals. A course of preventative or curative treatment can be identified based on the identified risk from the model. In one specific application, an individual identified by the model as at-risk for type 2 diabetes could be proscribed a preventative treatment, including, for example, based on risk factors associated with his/her specific “file”, such as obesity, dietary habits, etc. If the purpose of risk assessment is to identify a certain number of beneficiaries at highest risk, so as to perform an intervention on them, then a definition with high specificity should be employed, so that model predictions have highest accuracy for the most severe cases who will undergo intervention first. On the other hand, if a low cost intervention is applied to all beneficiaries with slightest risk of developing diabetes, model fitting should be done with outcome labels with highest sensitivity. Based on the evaluated positive predictive value of the prediction method on the selected subset (i.e. top 1000, top 10,000, top 100,000, etc.), and the estimated success of intervention and estimated financial gain per intervention, one can evaluate the amount of financial resources that can be invested in the intervention program.

Although the technical process and model used to generate the predictions are novel and have high predictive accuracy, the ultimate impact of the predictions depends on the interventions that are derived from them. In particular, for embodiments derived from insurance data, the goal of the interventions is to get insured members to see a healthcare provider that can diagnose and treat any existing condition, or provide education and resources needed to delay or avoid the onset of condition. Currently, health insurers can influence an insured member's healthcare through three basic channels; directly to the insured member, through the health care providers within the insurer's network, and through employer groups that purchase insurance on behalf of their employees. The interventions described here are intended to be examples of how the information from the model and process described herein can be used in each of these settings and should not be considered a complete list of interventions.

One intervention involves sending messages, such as SMS text, to members who have a predicted probability of developing diabetes within the next 24 months of >=0.70 and who have not seen a vision provider such as an optometrist or ophthalmologist within the past 12 months. Early indication of diabetes can be identified through a routine vision exam. Diabetic retinopathy usually has no early warning signs and can be one of the earliest indications of diabetes. A comprehensive eye examination can identify early stage disease by looking for leaking blood vessels, macular edema, pale, fatty deposits on the retina, damaged nerve tissue, and changes to the retinal blood vessels. The text message encourages the member to see their vision provider and links to a provider-finder to help the member select the appropriate doctor. Thus, the patient is directed to a medical professional who may further confirm the condition.

Another intervention involves sending primary care physicians (PCPs) lists of their patients who have high probabilities of having or getting diabetes. The PCP reviews the patient's medical chart and determines whether or not to bring the patient in for further evaluation. If during the evaluation the patient is identified as diabetic the physician shall provide appropriate care. If diabetes is not currently indicated the PCP provides the patient with their risk score and describes the patient's clinical risk factors for diabetes. The PCP and patient then agree on appropriate next steps, which may include enrolling in a diabetes prevention program. Thus, the intervention may provide steps for reducing the risk of developing the condition.

Health insurance companies typically run a variety of case and disease management programs aimed at keeping insured members healthy and out of the hospital. Another intervention that leverages the diabetes risk predictions involves providing clinical case and disease management staff with risk scores for members that are enrolled in a case management or disease management program. Using their existing relationship with the member, the case manager can discuss the member's risk profile and encourage them to see their PCP for treatment. Case managers can also assist in making the appointment and follow up with the member following their PCP visit. Thus, the intervention may provide an indication for case managers in dealing with the overall health advice given to a patient.

Understanding the future burden of disease can help employers plan benefit design changes, set up wellness programs, and make workplace modifications such as removing vending machines and building walking tails to reduce the anticipated disease burden. One intervention involves providing employer groups with a report summarizing the anticipated disease burden, which includes the number and percent of current diabetics, the number and percent that have a 70%, 80%, and 90% chance or greater of developing diabetes within the next 24 months. The report also provides heat maps of current and predicted disease burden by census track. Together, these elements constitute a consultative tool that can be used to select the right kind of remediation. Thus, the aggregate risk information for a population of patients can be utilized to make group decisions or business decisions relation got healthcare.

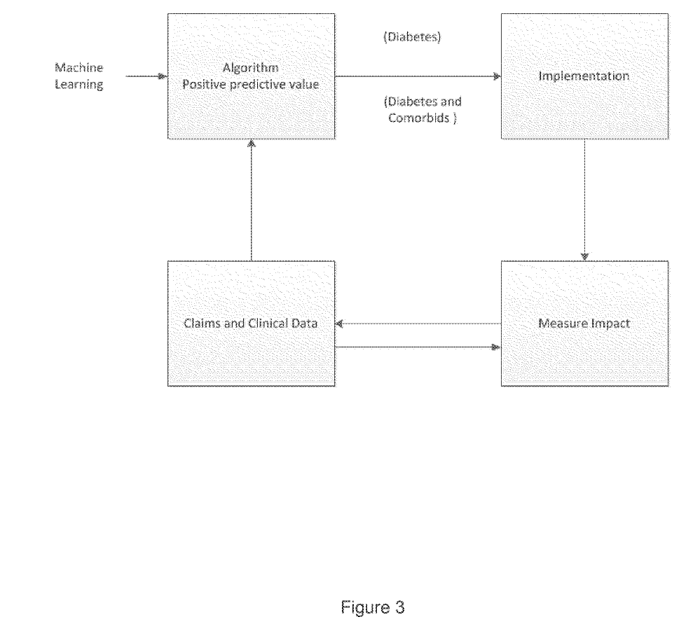

FIG. 3 illustrates a generalization of phase one and phase two of a method described herein. Claims data is utilized with a machine learning algorithm to discover predictive variables and surrogates. An intervention is implemented for a population based upon the predicted risk for a disease. The impact can be measured, the cost/benefit analyzed. The impact of the intervention on future claims data can be analyzed.

In a further embodiment, the model and application of the model can be used with regard to comorbid conditions. If the model predicts a certain risk level for a condition, for example type 2 diabetes, then a further model can be utilized to predict the occurrence of comorbid conditions. In the example if a determination of type 2 diabetes, or a risk of type 2 diabetes, then the risk of comorbid cardiovascular, cerebrovascular, renal, and eye conditions can be predicted. A similar process using as previously described above can be utilized to develop a model based upon the initial variable set. The algorithm is applied to discover predictive variables for each of the comorbidities of a disease. The comorbidity model may be applied, in one embodiment, after a confirmation of the primary condition by the model, such as a clinical confirmation of type 2 diabetes. The comorbidity predictions may be used to provide a specific intervention scheme, such as by predicting the organs or body functions impacted by the comorbid conditions and suggesting treatment with the appropriate medical professional. For example, individuals identified as diabetic or at high risk for developing diabetes can be directed to an ophthalmologist for possible treatment of comorbid eye conditions, something that the individual patient may not be aware when diagnosed with diabetes.

### Study Results

As a proof-of-concept example, a study was done to develop a population-level risk prediction model for Type 2 diabetes that can be directly applied to health insurance claims and other readily available clinical and utilization data as the patient data file to assess the risk for the patient. A retrospective cohort study was performed in beneficiaries of an insurance provider. The primary data source for the study was insurance claims data, which included enrollment information, utilization records such as hospitalizations, outpatient visits, laboratory orders, and pharmacy claims, for all beneficiaries, and laboratory test results for 95% percent of the lab claims. The initial study population included approximately 4.1 million de-identified insurance beneficiaries at least 18 years of age, who enrolled with a commercial insurance plan between the years 2005 and 2013.

The primary outcome for the study was the confirmed diagnosis of Type 2 diabetes. A beneficiary was confirmed as having Type 2 diabetes if any of the following three criteria were observed on two distinct days: (1) an International Classification of Diseases, Clinical Modification (ICD-9-CM) code of 250.xx, listed as a hospital discharge diagnosis or physician clinical encounter; (2) Use of a diabetes medication other than Metformin, or; (3) HbA1C value ≧6.5%. This definition of type 2 diabetes was based on evaluating the definition on a cohort of patients with clear marker of type 2 diabetes or clear marker of lack of type 2 diabetes. In order for the results to generalize well to the entire cohort, this subset of patients was adjusted with confirmed clear outcome, to the entire training data, by subsampling them according to the joint distribution of the original cohort. Age, gender, how long the beneficiary has been enrolled (measured by year), hypertension, hypercholesterolemia, and cardiovascular disease were used as the features for matching and subsampling. The definition included here had optimum specificity and sensitivity on this subsampled set, therefore selected as the definition of diabetes hereafter in this embodiment.”

A parsimonious model was built using risk factors derived from six landmark studies of risk assessment models for predicting incident diabetes: ARIC, KORA, FRAMINGHAM, AUSDRISC, FINDRISC, and the San Antonio Model. These risk factors included: age, sex, overweight, underweight, diagnosis of obesity, hypercholesterolemia, cardiovascular disease, lipid disorder, high alcohol in blood, unspecified hypertension, fasting glucose level, triglyceride level, C-reactive protein level and HDL. For purposes of this study, the diagnosis of obesity was included as a surrogate variable for BMI, and the diagnoses of hypertension and hypertensive heart and renal diseases as surrogates for elevated blood pressure. The model was calibrated, that is the same data used to train the models was used for the machine learning phase.

An enhanced model was built using beneficiary demographics, all past and current medical conditions, procedures, physician specialty visits, laboratory orders and results, and medication utilization in the insurance database. For purposes of the study described below, each beneficiary was represented as a set of approximately 42,000 variables that summarized all their past and current medical state. These variables were not selected specifically for the purpose of studying Type 2 diabetes. Thus, the approach of the study allowed for discovery of novel risk factors associated with Type 2 diabetes. The full set of variables include: beneficiary demographics (11 continuous and binary variables) including age as 1 continuous variable in addition to 3 binary variables for age bins of 18 to 39, 40 to 64, and 65+, gender, and months with vision and dental insurance coverage; all past and current medical conditions (16632 binary variables); temporal undergone procedures (457 variables at 3 different time buckets); temporal physician specialty visits (50x3 binary variables); temporal laboratory orders and results (7000x3 binary variables); and temporal medication utilization (990x3 binary variables). Medical conditions were encoded as indicator variables, based on all International Classification of Diseases (ICD-9) diagnosis codes. The study did not encode past medical conditions temporally. Procedure information variables were based on the Current Procedure Terminology (CPT) and ICD-9 Procedural codes, each grouped by Clinical Classification Software. Additional variables included indicators for visiting every physician specialty possible in clinical encounters (which is available in claims data), and indicators for all medications as specified by the National Drug Code (NDC) and grouped by therapeutic class codes. Patient laboratory measurement variables were based on Logical Observation Identifiers Names and Codes (LOINC) numbers. The study used the 1000 most frequent laboratory tests based on our cohort. For each of these laboratory tests at each time span considered, 7 variables were derived: an indicator of whether the test was administered, an indicator for whether the result was reported as low, high, or normal according to the reference range of the laboratory, whether the value increased, decreased or fluctuated. If a variable was not observed it was to be 0 and did not impute it.

For every temporal variable, the time in which they could be assessed can be varied. For purposes of the example study, three separate temporal variables were used indicating whether the lab test triglyceride was high in the past 6 months, past 2 years, as well as in the entire patient history.

In total, each beneficiary was represented as a set of approximately 42,000 variables that summarized all their past and current medical state. These variables were not selected specifically for the purpose of studying Type 2 diabetes. Thus, the approach of the study allowed for discovery of novel risk factors associated with Type 2 diabetes.

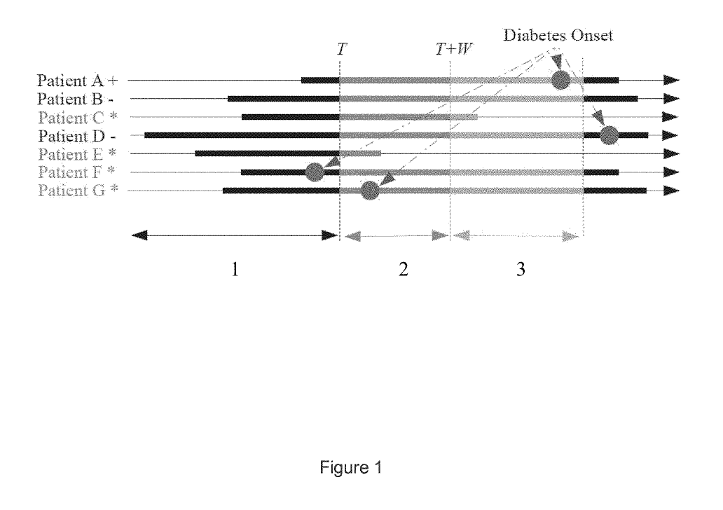

The study was designed to determine risk of developing Type 2 diabetes after Jan. 1, 2009 (hereafter denoted as time T, the baseline). Three prediction tasks were considered corresponding to a gap period (W) of 0, 1, and 2 years after T. Excluding beneficiaries diagnosed with Type 2 diabetes within W years of baseline, it was determined which individuals would be newly diagnosed within the 2-year period following T+W (i.e., 2009 to 2011 for Gap=0, 2010 to 2012 for Gap=1, and 2011 to 2013 for Gap=2). Beneficiaries were excluded who did not have continuous enrollment during the gap period and prediction window. Additionally, a minimum of 6 months of enrollment prior to the prediction time T was required. This framework is summarized in FIG. 1. In data collection period 1, features are derived from patient data up to time T. A gap period 2, of size W, follows between data collection and outcome evaluation. Outcome is then evaluated in the two-year follow-up window (period 3). Patients who have diabetes before T+W, or have insufficient enrollment, are excluded during training and evaluation (denoted as *). Patient outcome is positive (denoted as +) if diabetes onset happens in the outcome evaluation period, and negative (denoted as −) otherwise.

The prediction models in the study were developed using sparse, or L1-regularized, logistic regression. For the study, the data set was validated using fold-based cross validation. For the illustrative study, a randomly selected 67% of the data was used for training, with the remaining 33% held out for the validation set, and used a 5-fold cross-validation on the training data to choose the level of regularization and fit the parameters. The study used the same methodology to fit the parameters of the parsimonious model.

For each predictive model, the area under the receiver-operating curve (AUC) was calculated, as well as Positive Predictive Value (PPV) for the 100, 1000, and 10000 top predictions, using the validation data. We calculated the odds ratio (OR) for each discovered risk factor, and present them for three age categories. In all cases, the unadjusted odds ratios are reported directly calculated from the data, linking each risk factor to the diabetes onset independent of other variables. For all reported risk factors, the study herein reports 95% confidence intervals (CI) in addition to p-values for the odds ratios. To report AUC confidence intervals, a standard error upper bound and 95% confidence intervals were used. For PPV, 95% confidence interval was used. In all comparisons, the Wald test was used for reporting p-values of differences.

The results of the study validate the system and methods described herein. The original cohort included about 4.1 million beneficiaries, whose characteristics are shown in Table 1. A total of 742,407 beneficiaries matched the inclusion criteria for predicting onset of Type 2 diabetes between 2009 and 2011 using beneficiaries' data up to 2009. Of these, 18,054 had a positive outcome label (onset of Type 2 diabetes) in the evaluation window. After training, 886 variables were selected for the enhanced model. For predicting onset of Type 2 diabetes between 2010 and 2012 (Gap=1), 653,038 beneficiaries matched the inclusion criteria, with 12,936 beneficiaries having a positive label in the evaluation window. After training, 717 variables were selected in the enhanced model as predictive. For predicting onset of Type 2 diabetes between 2011 and 2013 (Gap=2), 589,729 beneficiaries matched our inclusion criteria, 7,955 of which had a positive label in the evaluation window. After training, 507 variables were selected as predictive.

TABLE 1
Subjects Characteristics of the cohort
included in training and validation

| Characteristic | Total population | Population with diabetes |
|---|---|---|
| Average Age (Standard | 47.69 (17.1) | 58.57 (13.3) |
| Deviation) | | |
| Female ratio | 55% | 51% |
| Average length of data in | 3.3 (1.0) | 3.4 (1.0) |
| years (Standard Deviation) | | |
| Hypertension (ICD9 401) | 30.2% | 62% |
| Hyper Cholesterolemia | 18.7% | 33.6% |
| (ICD9 272.0) | | |

Table 2 shows comparisons of prediction quality measures between parsimonious and enhanced models for different time gap periods. PPV values for the top 100, 1000 and 10000 predictions were between 1.5 to 2 times higher in the enhanced model than the parsimonious model. Our models are highly specific, and the sensitivity increases to 21% at the 10000 level. Predicting onset of diabetes further into the future, with a larger gap between data collection and the evaluation window, is (expectedly) less accurate. For all prediction windows, the enhanced model significantly outperforms the parsimonious model (p<0.0001 for differences in AUCs).

TABLE 2
Performance for prediction of diabetes, using patient data through Dec. 31^{st} 2008, within the different prediction windows

| Prediction | | | Top 100† | | | Top 1000† | | | Top 10000† | | |
|---|---|---|---|---|---|---|---|---|---|---|---|
| Window | Model | AUC*† | Sensitivity | Specificity | PPV | Sensitivity | Specificity | PPV | Sensitivity | Specificity | PPV |
| 2009 to | Parsimonious | 0.75 | .001 | .999 | 0.12 | .014 | .996 | 0.10 | .114 | .967 | 0.08 |
| 2011 | Model | | | | | | | | | | |
| | Enhanced | 0.80 | .005 | .999 | 0.37 | .033 | .997 | 0.23 | .216 | .969 | 0.15 |
| | Model | | | | | | | | | | |
| 2010 to | Parsimonious | 0.74 | .001 | .999 | 0.06 | .014 | .996 | 0.07 | .117 | .962 | 0.06 |
| 2012 | Model | | | | | | | | | | |
| | Enhanced | 0.78 | .002 | .999 | 0.15 | .035 | .996 | 0.17 | .203 | .963 | 0.10 |
| | Model | | | | | | | | | | |
| 2011 to | Parsimonious | 0.72 | .0009 | .999 | 0.03 | .012 | .995 | 0.04 | .118 | .957 | 0.03 |
| 2013 | Model | | | | | | | | | | |
| | Enhanced | 0.76 | .003 | .999 | 0.10 | .024 | .995 | 0.07 | .195 | .958 | 0.06 |
| | Model | | | | | | | | | | |

*Differences in AUC significant with p < .0001 in this validation set
†All reported values have 95 percent confidence interval of less than 0.002

Table 3 shows the top predictive variables for immediate (gap=0) onset of diabetes. For every predictive variable we present unadjusted odds ratios and corresponding p-values as well as the unadjusted odds ratio for three age categories. Most top variables are directly related to pre-diabetes or diabetes, including history of pre-diabetes or related conditions, elevated glucose, elevated HbA1c, and Metformin medication utilization. However, other variables such as history of sleep apnea, acute bronchitis, hypothyroidism and anemia, as well as high serum alanine aminotransferase all have significant predictive value for immediate confirmation of onset of diabetes. Measures of healthcare utilization also contribute to the prediction of onset of Type 2 diabetes.

TABLE 3
Top predictive variables for Type 2 diabetes onset within 2009-2010 (Gap = 0), using patient data through Dec. 31,
2008. Shown here are the variables with the highest magnitude of beta coefficient, sorted by the unadjusted odds ratio.

| | Variable | | Number | Number | | | | | p- |
|---|---|---|---|---|---|---|---|---|---|
| Variable | evaluation | Variable | with | without | Odds ratio | OR for | OR for | OR for | value |
| Type | period* | Description | diabetes | diabetes | (95% CI) | 18 ≦ age < 40 | 40 ≦ age < 65 | 65 ≦ age | of OR |
| Lab test | Past 2 | Hemoglobin A1c/ | 1845 | 8710 | 9.28 | 23.01 | 8.42 | 4.34 | <.001 |
| | years | Hemoglobin · total − | | | (8.81 9.78) | (16.8 31.40) | (7.85 9.03) | (4.00 4.72) | |
| | | high (loinc-4548-4) | | | | | | | |
| | Past 2 | Glucose-high | 5274 | 58736 | 4.58 | 9.42 | 3.68 | 2.42 | <.001 |
| | years | (loinc-2345-7) | | | (4.43 4.73) | (7.90 11.24) | (3.52 3.84) | (2.29 2.56) | |
| | Past 2 | Hemoglobin | 3908 | 45519 | 4.06 | 5.90 | 3.41 | 2.56 | <.001 |
| | years | A1c/Hemoglobin · | | | (3.92 4.21) | (5.03 6.91) | (3.25 3.57) | (2.40 2.73) | |
| | | total − request for | | | | | | | |
| | | test (loinc-4548-4) | | | | | | | |
| | Entire | Cholesterol · in | 3233 | 49524 | 2.94 | 4.72 | 2.41 | 1.99 | <.001 |
| | history | HDL − low | | | (2.83 3.06) | (3.99 5.59) | (2.29 2.53) | (1.86 2.14) | |
| | | (loinc-2085-9) | | | | | | | |
| | Entire | Triglyceride − high | 6056 | 106818 | 2.85 | 3.92 | 2.29 | 1.64 | <.001 |
| | history | (loinc-2571-8) | | | (2.77 2.94) | (3.37 4.55) | (2.20 2.38) | (1.55 1.73) | |
| | Entire | Cholesterol · total/ | 3114 | 56032 | 2.46 | 4.12 | 2.04 | 1.47 | <.001 |
| | history | Cholesterol · in HDL − | | | (2.37 2.56) | (3.41 4.99) | (1.94 2.14) | (1.37 1.58) | |
| | | high (loinc-9830-1) | | | | | | | |
| | Entire | Alanine | 1208 | 22205 | 2.26 | 3.49 | 2.00 | 1.53 | <.001 |
| | history | aminotransferase − | | | (2.13 2.40) | (2.74 4.46) | (1.86 2.15) | (1.37 1.72) | |
| | | high (loinc-1742-6) | | | | | | | |
| | Entire | Cholesterol · in | 3029 | 63166 | 2.09 | 2.60 | 1.67 | 1.54 | <.001 |
| | history | VLDL − request for | | | (2.01 2.18) | (2.16 3.14) | (1.59 1.76) | (1.44 1.65) | |
| | | test (loinc-13458-5) | | | | | | | |
| | Entire | Cholesterol · total/ | 3277 | 75701 | 1.89 | 2.76 | 1.40 | 1.07 | <.001 |
| | history | Cholesterol · in HDL − | | | (1.81 1.96) | (2.15 3.55) | (1.33 1.48) | (1.01 1.14) | |
| | | decreasing | | | | | | | |
| | | (loinc-9830-1) | | | | | | | |
| | Past 2 | Carbon dioxide − | 6044 | 158472 | 1.77 | 2.59 | 1.28 | 1.12 | <.001 |
| | years | request for test | | | (1.72 1.83) | (2.25 2.98) | (1.23 1.34) | (1.06 1.18) | |
| | | (loinc-2028-9) | | | | | | | |
| ICD9 | Entire | Abnormal glucose | 1198 | 10099 | 5.00 | 10.64 | 4.31 | 2.64 | <.001 |
| History | history | (ICD9 790.29) | | | (4.70 5.32) | (7.89 14.35) | (3.98 4.68) | (2.39 2.92) | |
| | Entire | Impaired fasting | 1285 | 11521 | 4.72 | 9.82 | 4.04 | 2.38 | <.001 |
| | history | glucose | | | (4.45 5.01) | (6.69 14.41) | (3.74 4.37) | (2.16 2.62) | |
| | | (ICD9 790.21) | | | | | | | |
| | Entire | Hypertension | 12175 | 227759 | 4.09 | 4.77 | 2.94 | 1.95 | <.001 |
| | history | (ICD9 401) | | | (3.97 4.22) | (4.21 5.41) | (2.84 3.05) | (1.83 2.09) | |
| | Entire | Chronic liver | 619 | 6845 | 3.71 | 7.46 | 3.32 | 2.00 | <.001 |
| | history | disease | | | (3.41 4.03) | (5.22 10.66) | (3.01 3.66) | (1.68 2.39) | |
| | | (ICD9 571.8) | | | | | | | |
| | Entire | Obesity | 3104 | 48000 | 2.90 | 4.71 | 2.85 | 1.97 | <.001 |
| | history | (ICD9 278) | | | (2.78 3.01) | (4.10 5.40) | (2.71 2.98) | (1.81 2.14) | |
| | Entire | Obstructive sleep | 1178 | 17302 | 2.84 | 4.11 | 2.48 | 1.81 | <.001 |
| | history | apnea | | | (2.67 3.02) | (3.07 5.50) | (2.30 2.66) | (1.60 2.05) | |
| | | (ICD9 327.23) | | | | | | | |
| | Entire | Hypersomnia with | 1138 | 16965 | 2.79 | 4.15 | 2.38 | 1.83 | <.001 |
| | history | sleep apnea | | | (2.63 2.97) | (3.04 5.67) | (2.21 2.56) | (1.62 2.08) | |
| | | (ICD9 780.53) | | | | | | | |
| | Entire | Abnormal blood | 2388 | 38726 | 2.68 | 3.54 | 2.28 | 1.57 | <.001 |
| | history | chemistry | | | (2.56 2.80) | (2.83 4.43) | (2.15 2.41) | (1.46 1.69) | |
| | | (ICD9 790.6) | | | | | | | |
| | Entire | Hyperlipidemia | 8745 | 186016 | 2.62 | 3.31 | 1.86 | 1.40 | <.001 |
| | history | (ICD9 272.4 | | | (2.54 2.69) | (2.87 3.82) | (1.79 1.93) | (1.33 1.48) | |
| | Entire | Anemia | 3421 | 75500 | 1.99 | 2.74 | 1.63 | 1.39 | <.001 |
| | history | (ICD9 285.9) | | | (1.92 2.07) | (2.34 3.20) | (1.55 1.72) | (1.31 1.48) | |
| | Entire | Hypothyroidism | 3803 | 87228 | 1.93 | 3.35 | 1.53 | 1.17 | <.001 |
| | history | (ICD9 244.9) | | | (1.86 2.00) | (2.85 3.93) | (1.46 1.60) | (1.10 1.25) | |
| | Entire | Acute bronchitis | 3229 | 93559 | 1.46 | 1.64 | 1.30 | 1.20 | <.001 |
| | history | (ICD9 466.0) | | | (1.41 1.52) | (1.40 1.92) | (1.24 1.37) | (1.12 1.29) | |
| NDC | Entire | Medication Group: | 286 | 1142 | 10.17 | 17.17 | 11.38 | 12.76 | <.001 |
| Medication | history | Metformin | | | (8.93 11.59) | (12.67 23.25) | (9.57 13.53) | (9.36 17.39) | |
| History | | | | | | | | | |
| | Entire | Medication Group: | 3055 | 88506 | 1.46 | 1.74 | 1.25 | 1.22 | <.001 |
| | history | Anti-arthritics | | | (1.40 1.51) | (1.49 2.03) | (1.19 1.32) | (1.14 1.31) | |
| | Entire | Medication Group: | 3216 | 94531 | 1.44 | 1.72 | 1.24 | 1.22 | <.001 |
| | history | Non-steroidal anti- | | | (1.38 1.49) | (1.47 2.00) | (1.18 1.30) | (1.14 1.31) | |
| | | inflammatory drugs | | | | | | | |
| Health-care | Past 2 | Procedure Group: | 5505 | 131707 | 1.94 | 1.86 | 1.60 | 1.30 | <.001 |
| utilization | years | Routine Chest X | | | (1.88 2.01) | (1.61 2.15) | (1.53 1.67) | (1.23 1.37) | |
| | Entire | Service Place | 4386 | 113223 | 1.72 | 1.69 | 1.56 | 1.26 | <.001 |
| | history | Code: Home | | | (1.66 1.77) | (1.47 1.94) | (1.49 1.63) | (1.19 1.34) | |
| | Entire | Dental Coverage = | 4142 | 119108 | 1.50 | 1.04 | 1.05 | 1.17 | <.001 |
| | history | Yes | | | (1.45 1.55) | (0.89 1.23) | (0.99 1.11) | (1.11 1.24) | |
| | Entire | Specialty Code: | 7246 | 227156 | 1.45 | 1.64 | 1.12 | 1.00 | <.001 |
| | history | Internal Medicine | | | (1.40 1.49) | (1.46 1.86) | (1.08 1.16) | (0.95 1.05) | |
| | Entire | Procedure group: | 6681 | 247300 | 1.13 | 0.86 | 1.04 | 0.89 | <.001 |
| | history | Ophthalmologic | | | (1.09 1.16) | (0.76 0.97) | (1.00 1.08) | (0.84 0.93) | |
| | | and otologic | | | | | | | |
| | | diagnosis and | | | | | | | |
| | | treatment | | | | | | | |

*Entire history refers to our current setting and cohort, which is limited to max 4 years before 2009.

Table 4 shows the top predictive variables for diabetes onset 1-3 years after the data collection period. Not surprisingly, previously identified risk factors such as high glucose, high A1c, obesity, and impaired fasting glucose emerged as strongly predictive of diabetes diagnosis. Interestingly, 1 year before the confirmed diagnosis of diabetes, shortness of breath, esophageal reflux, and acute bronchitis also have significant predictive value. Healthcare usage variables such as need for emergency-room service and routine child health exam are also significant in assessment of risk of impending diabetes.

TABLE 4
Top predictive variables for Type 2 diabetes onset within 2010-2012 (Gap = 1), using patient data through Dec. 31,
2008. Shown here are the variables with the highest magnitude of beta coefficient, sorted by the unadjusted odds ratio.

| | Variable | | Number | Number | | | | | p- |
|---|---|---|---|---|---|---|---|---|---|
| Variable | evaluation | Variable | with | without | Odds ratio | OR for | OR for | OR for | value |
| Type | period* | Description | diabetes | diabetes | (95% CI) | 18 ≦ age < 40 | 40 ≦ age < 65 | 65 ≦ age | of OR |
| Lab test | Entire | Hemoglobin A1c / | 1323 | 12344 | 5.75 | 7.98 | 5.46 | 2.74 | <.001 |
| | History | Hemoglobin · Total − | | | (5.42 6.10) | (5.58 11.41) | (5.05 5.90) | (2.49 3.02) | |
| | | High (Loinc-4548-4) | | | | | | | |
| | Past 2 | Glucose − High | 3389 | 50745 | 4.05 | 7.31 | 3.24 | 2.25 | <.001 |
| | years | (Loinc-2345-7) | | | (3.89 4.21) | (5.88 9.10) | (3.07 3.41) | (2.10 2.40) | |
| | Past 2 | Hemoglobin A1c/ | 2389 | 39347 | 3.42 | 5.11 | 2.90 | 2.14 | <.001 |
| | years | Hemoglobin · | | | (3.27 3.58) | (4.23 6.17) | (2.74 3.07) | (1.97 2.32) | |
| | | Total − Request For Test | | | | | | | |
| | Entire | Hemoglobin A1c/ | 3111 | 58061 | 3.13 | 4.63 | 2.63 | 1.94 | <.001 |
| | History | Hemoglobin · Total − | | | (3.00 3.26) | (3.91 5.47) | (2.49 2.77) | (1.81 2.09) | |
| | | Request For Test | | | | | | | |
| | Entire | Cholesterol · In | 2172 | 42888 | 2.78 | 4.69 | 2.27 | 1.90 | <.001 |
| | History | HDL − Low | | | (2.66 2.92) | (3.88 5.68) | (2.142.41) | (1.75 2.08) | |
| | | (Loinc-2085-9) | | | | | | | |
| | Entire | Cholesterol · Total/ | 2082 | 49026 | 2.29 | 4.00 | 1.87 | 1.42 | <.001 |
| | History | Cholesterol · In HDL − | | | (2.19 2.40) | (3.22 4.97) | (1.76 1.98) | (1.30 1.55) | |
| | | High (Loinc-9830- | | | | | | | |
| | | 1) | | | | | | | |
| | Entire | Cholesterol · In | 2277 | 55592 | 2.23 | 2.43 | 1.80 | 1.67 | <.001 |
| | History | VLDL − Request | | | (2.13 2.33) | (1.96 3.01) | (1.70 1.91) | (1.54 1.81) | |
| | | For Test (Loinc- | | | | | | | |
| | | 13458-5) | | | | | | | |
| | Entire | Carbon Dioxide − | 5157 | 186669 | 1.58 | 2.58 | 1.13 | 0.99 | <.001 |
| | History | Request For Test | | | (1.53 1.64) | (2.24 2.96) | (1.08 1.18) | (0.93 1.06) | |
| | | (Loinc-2028-9) | | | | | | | |
| | Past 2 | Glomerular | 3560 | 123104 | 1.58 | 2.37 | 1.15 | 1.04 | <.001 |
| | years | Filtration Rate/1.73 | | | (1.52 1.64) | (2.00 2.81) | (1.09 1.21) | (0.97 1.11) | |
| | | Sq. M · | | | | | | | |
| | | Predicted · Black − | | | | | | | |
| | | Request For Test | | | | | | | |
| | | (Loinc-48643-1) | | | | | | | |
| ICD9 | Entire | Impaired Fasting | 800 | 9918 | 4.17 | 7.05 | 3.42 | 2.33 | <.001 |
| History | History | Glucose (ICD9- | | | (3.87 4.49) | (4.27 11.65) | (3.10 3.77) | (2.07 2.62) | |
| | | 790.21) | | | | | | | |
| | Entire | Abnormal Glucose | 690 | 8695 | 4.07 | 7.46 | 3.46 | 2.28 | <.001 |
| | History | NEC (ICD9- | | | (3.76 4.41) | (5.05 11.00) | (3.12 3.84) | (2.01 2.60) | |
| | | 790.29) | | | | | | | |
| | Entire | Hypertension | 6026 | 130309 | 3.28 | 4.60 | 2.55 | 1.64 | <.001 |
| | History | (ICD9-401) | | | (3.17 3.39) | (3.88 5.44) | (2.44 2.66) | (1.53 1.75) | |
| | Entire | Obstructive Sleep | 867 | 14979 | 2.98 | 4.50 | 2.61 | 1.89 | <.001 |
| | History | Apnea (ICD9-327.23) | | | (2.78 3.20) | (3.30 6.15) | (2.40 2.84) | (1.63 2.19) | |
| | Entire | Obesity (ICD9 278) | 2189 | 41850 | 2.88 | 4.44 | 2.81 | 2.01 | <.001 |
| | History | | | | (2.75 3.02) | (3.80 5.19) | (2.66 2.97) | (1.81 2.22) | |
| | Entire | Abnormal Blood | 1588 | 33877 | 2.49 | 3.81 | 2.08 | 1.51 | <.001 |
| | History | Chemistry (ICD9- | | | (2.36 2.62) | (2.99 4.86) | (1.94 2.23) | (1.38 1.65) | |
| | | 790.6) | | | | | | | |
| | Entire | Hyperlipidemia | 6017 | 163558 | 2.45 | 3.09 | 1.74 | 1.40 | <.001 |
| | History | (ICD9 272.4) | | | (2.37 2.53) | (2.63 3.65) | (1.66 1.81) | (1.31 1.50) | |
| | Entire | Shortness Of | 2132 | 54848 | 2.09 | 2.23 | 1.78 | 1.38 | <.001 |
| | History | Breath (ICD9- | | | (1.99 2.19) | (1.80 2.76) | (1.67 1.89) | (1.28 1.50) | |
| | | 786.05) | | | | | | | |
| | Entire | Esophageal Reflux | 2889 | 85302 | 1.85 | 2.12 | 1.52 | 1.23 | <.001 |
| | History | (ICD9-530.81) | | | (1.78 1.93) | (1.75 2.56) | (1.44 1.60) | (1.14 1.32) | |
| | Entire | Acute Bronchitis | 2273 | 82255 | 1.44 | 1.49 | 1.30 | 1.20 | <.001 |
| | History | (ICD9-466.0) | | | (1.37 1.50) | (1.24 1.78) | (1.22 1.37) | (1.11 1.31) | |
| NDC | Past 2 | Medication Group: | 2109 | 76497 | 1.43 | 1.67 | 1.22 | 1.22 | <.001 |
| medications | years | Anti-arthritics | | | (1.36 1.50) | (1.40 2.00) | (1.15 1.29) | (1.12 1.33) | |
| | Entire | Medication Group: | 2230 | 81802 | 1.41 | 1.68 | 1.20 | 1.23 | <.001 |
| | History | Anti-arthritics | | | (1.35 1.48) | (1.41 2.00) | (1.14 1.28) | (1.13 1.33) | |
| Health-care | Entire | Procedure Group: | 4973 | 152365 | 1.96 | 2.05 | 1.58 | 1.33 | <.001 |
| utilization | History | Routine Chest X- | | | (1.89 2.03) | (1.78 2.36) | (1.51 1.66) | (1.24 1.41) | |
| | | ray | | | | | | | |
| | Entire | Dental Coverage = | 2919 | 105445 | 1.47 | 1.08 | 1.08 | 1.14 | <.001 |
| | History | Yes | | | (1.41 1.53) | (0.90 1.30) | (1.01 1.16) | (1.07 1.22) | |
| | Entire | Service Place: | 5920 | 246865 | 1.32 | 1.39 | 1.41 | 1.29 | <.001 |
| | History | Emergency Room - | | | (1.28 1.37) | (1.23 1.56) | (1.35 1.47) | (1.21 1.37) | |
| | | Hospital | | | | | | | |
| | Entire | Specialty Code: | 6946 | 314429 | 1.18 | 1.28 | 0.98 | 1.01 | <.001 |
| | History | Independent | | | (1.14 1.22) | (1.13 1.44) | (0.94 1.02) | (0.95 1.08) | |
| | | Laboratory | | | | | | | |
| | Entire | Routine Medical | 3432 | 191452 | 0.85 | 1.06 | 0.76 | 0.75 | <.001 |
| | History | Exam (ICD9 V700) | | | (0.82 0.88) | (0.92 1.22) | (0.72 0.79) | (0.70 0.81) | |
| | Entire | Routine | 4448 | 246649 | 0.84 | 1.75 | 0.69 | 0.86 | <.001 |
| | History | Gynecological | | | (0.81 0.87) | (1.55 1.97) | (0.66 0.72) | (0.80 0.92) | |
| | | Examination (ICD9 | | | | | | | |
| | | V7231) | | | | | | | |
| | Entire | Routine Child | 175 | 76181 | 0.10 | 0.31 | 0.41 | 0.39 | <.001 |
| | History | Health Exam | | | (0.09 0.12) | (0.26 0.36) | (0.29 0.58) | (0.05 2.82) | |
| | | (ICD9 V202 ) | | | | | | | |

*Entire history refers to our current setting and cohort, which is limited to max 4 years before 2009.

The validation study undertaken used model fitting and validation using data from more than 740,000 commercial health plan beneficiaries and 42,000 variables. The outcome for Type 2 diabetes was derived using a gold standard for accuracy. Using retrospective data, the study evaluated the models' ability to identify individuals that will be newly diagnosed with Type 2 diabetes in the years following 2009. As described herein, the study demonstrated that compared to using a parsimonious set of variables, using big data and machine learning improves positive predictive values by 50% and AUC by 6.6%.

The quality of population-level risk assessment is critical when selecting intervention target population. The CDC's Diabetes Prevention Program (DPP) used mass media, mail, telephone and community networking methods to recruit about 3,000 patients based on weight and elevated glucose. Owing to missing data and cost considerations, these identification and outreach strategies are not feasible at a population level. Embodiments described herein are capable of utilizing data that are readily available to most insurance plans, and employ surrogate variables to compensate for missing data. The reported sensitivity, specificity and positive predictive values for our models can provide guidance for selection of intervention. For focused high-cost interventions, embodiments of the present invention are able to (with 39% positive predictive value) select the most vulnerable. When the interventions are more scalable they could be performed on the top 10,000 individuals, with a sensitivity of 21.2% in a validation set of more than 220,000 beneficiaries.

The risk factors identified in the enhanced model include many known risk factors such as obesity and elevated HbA1c values, but also include less well established risk factors that may act as surrogates for established risk factors. For example, only 6% of beneficiaries are documented as obese in the insurance claims, despite 35% of the American population being obese according to the Centers for Disease Control. On the other hand, esophageal reflux, which has a known connection to diabetes, is documented for 12.6% of population and we believe it is partly acting as a surrogate for obesity in our data. We believe there are similar effects for sleep apnea, shortness of breath, and eosinophilia, all of which have known associations with diabetes through obesity and hypertension.

Elevated liver function tests have been shown to be early manifestations of insulin resistance, and are known to be detectable earlier than fasting glycemia. Consistent with these results, we see high levels of alanine aminotransferase in the laboratory results and the presence of chronic liver disease to be highly predictive of diabetes onset, even 1 year before confirmed diagnosis. In applying methods and system of the described herein to the study described herein, hypothyroidism was selected as well, being known causal effects for insulin resistance. Similarly, in one embodiment, as used in the study, a number of variables related to renal disease and anemia, including a diagnosis of anemia, or iron deficiency, low Hematocrit values, as well as high urea nitrogen, high creatinine, and high estimated Glomerular Filtration rate were recovered by the method as predictive of diabetes onset. Finally, in the embodiment utilized in the study, the method selects acute bronchitis as predictive for diabetes.

Machine learning on insurance claims and administrative data provides a powerful new tool for population health, enabling population-level risk stratification that can help guide interventions to the most at risk population. Using the approach described herein, the study demonstrates that it is possible to identify patients likely to develop Type 2 diabetes in 0-2 years with an AUC of 0.80, and in 2-4 years with an AUC of 0.76.

It should be understood that a particular condition and or dataset utilized with systems and method described herein may present certain limitations. First, there may be more missing data among beneficiaries who have only recently enrolled in the health insurance plan or who have little health care utilization, reducing the sensitivity of the model among these beneficiaries. Two possible solutions would be to send a health questionnaire to a subset of the population, either at the time of enrollment or periodically, or to complement the administrative data with data gathered by other sources, such as by mobile health applications. In one embodiment, automatic requests for data are sent to a patient's primary care physician. The primary care physician can provide electronic data to augment the dataset.

Second, although machine learning of the enhanced model discovered several novel risk factors, the clinical significance of these factors needs further validation. In particular, further study is needed to assess whether there are confounding factors, either due to the nature of how the data were collected or to other clinical factors. The variable set or the disease variable set can be utilized, such as in a dedicated causality study, to aid in determining clinical significance.

Third, the study population may not be representative of the whole of the United States, as 80% of the studied population resides in the greater Philadelphia region, which may contribute both demographic and behavioral bias. Finally, the study's outcome is derived from clinical and utilization data, it cannot be used to determine if a person has existing but undiagnosed and untreated Type 2 diabetes. However, the systems and methods herein are useful for predicting future conditions, such as diabetes in the study, and to identify cases of undiagnosed or untreated conditions.

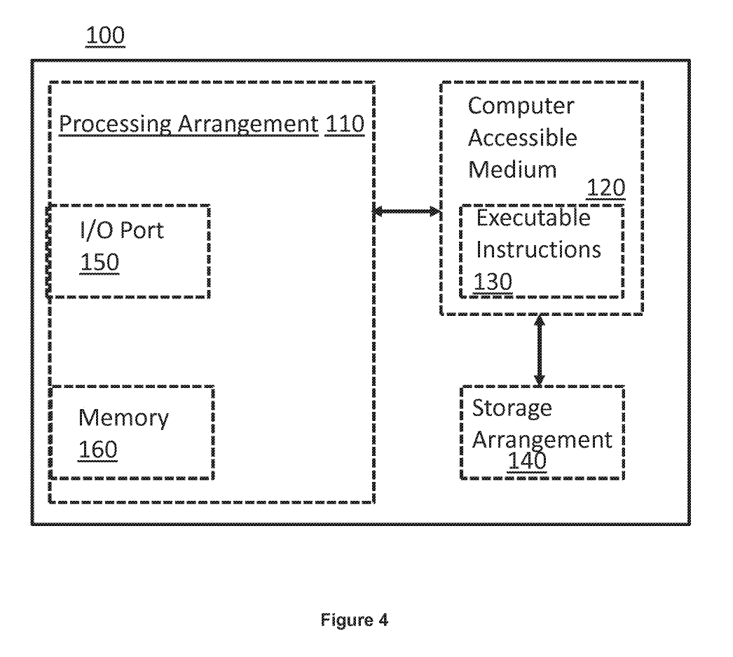

As shown in FIG. 4, e.g., a computer-accessible medium 120 (e.g., as described herein, a storage device such as a hard disk, floppy disk, memory stick, CD-ROM, RAM, ROM, etc., or a collection thereof) can be provided (e.g., in communication with the processing arrangement 110). The computer-accessible medium 120 may be a non-transitory computer-accessible medium. The computer-accessible medium 120 can contain executable instructions 130 thereon. In addition or alternatively, a storage arrangement 140 can be provided separately from the computer-accessible medium 120, which can provide the instructions to the processing arrangement 110 so as to configure the processing arrangement to execute certain exemplary procedures, processes and methods, as described herein, for example. The instructions may include a plurality of sets of instructions. For example, in some implementations, the instructions may include instructions for applying radio frequency energy in a plurality of sequence blocks to a volume, where each of the sequence blocks includes at least a first stage. The instructions may further include instructions for repeating the first stage successively until magnetization at a beginning of each of the sequence blocks is stable, instructions for concatenating a plurality of imaging segments, which correspond to the plurality of sequence blocks, into a single continuous imaging segment, and instructions for encoding at least one relaxation parameter into the single continuous imaging segment.

System 100 may also include a display or output device, an input device such as a key-board, mouse, touch screen or other input device, and may be connected to additional systems via a logical network. Many of the embodiments described herein may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art can appreciate that such network computing environments can typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Various embodiments are described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, are intended to encompass implementations using one or more lines of software code, and/or hardware implementations, and/or equipment for receiving manual inputs.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. Therefore, the above embodiments should not be taken as limiting the scope of the invention.

What is claimed:

1. A computer-implemented machine for identifying a risk of developing a condition comprising:
a processor; and
a tangible computer-readable medium operatively connected to the processor and including computer code configured to:
create an initial variable set having a plurality of patient variables;
applying a machine learning algorithm using the database to develop an enhanced model for the condition;
applying the enhanced model to a patient feature vector for a patient;
predicting the presence or absence of a condition in a patient; and
identify a course of preventative treatment based on the identified risk.

2. The computer-implemented machine of claim 1, wherein the application of the machine learning algorithm includes identifying correlation coefficients for each variable in the initial variable set as to correlation with the condition.

3. The computer-implemented machine of claim 1, wherein application of the machine learning algorithm sets the correlation coefficient as zero for variables that were not observed for a given patient.

4. The computer implemented machine of claim 2, wherein application of the machine learning algorithm further comprises identifying a disease variable set which is a subset of the initial variable set and includes variables having a correlation coefficient greater than a predetermined value, the diseased variable set utilized to develop the enhanced model.

5. The computer implemented machine of claim 4, wherein the diseased variable set utilized in the enhanced model includes a plurality of predictive variables and a plurality of surrogate variables.

6. The computer implemented machine of claim 5, wherein the patient feature vector is constructed from data for a plurality of patients corresponding to the plurality of patient variables.

7. The computer implemented machine of claim 6, wherein predicting the presence or absence of the condition in the patient comprises predicting the presence or absence of the condition for each patient of the plurality of patients.

8. The computer implemented machine of claim 6, further wherein the presence or absence of the condition corresponds to a prediction period of three years.

9. A method for identifying a risk of developing a condition for a particular patient comprising:
analyzing a database having a plurality information for a plurality of patients;
applying a machine learning algorithm using the database to develop a risk model for the condition;
identifying one or more surrogates for predictive variables in the risk;
identifying one or more preventative treatments associated with the condition.

10. The method of claim 9, wherein the application of the machine learning algorithm includes identifying correlation coefficients for each variable in the initial variable set as to correlation with the condition.

11. The method of claim 10, wherein application of the machine learning algorithm further comprises identifying a disease variable set which is a subset of the initial variable set and includes variables having a correlation coefficient greater than a predetermined value, the diseased variable set utilized to develop the enhanced model.

12. The method of claim 11, wherein the diseased variable set utilized in the enhanced model includes a plurality of predictive variables and a plurality of surrogate variables.

13. The method of claim 12, wherein the patient feature vector is constructed from data for a plurality of patients corresponding to the plurality of patient variables.

14. The method of claim 13, wherein predicting the presence or absence of the condition in the patient comprises predicting the presence or absence of the condition for each patient of the plurality of patients.

15. The method of claim 13, further wherein the presence or absence of the condition corresponds to a prediction period of three years.

16. A method for assessing the risk of individuals within a population developing a condition, comprising:
preparing patient data file containing a plurality of information about a patient;
applying a risk model based upon an insurance claim database; and
applying one or more surrogates identified by the risk model to address missing or incorrect data in the patient data file;
determining a risk for each individual within the population of developing the condition; and
identifying a course of preventative treatment based on the identified risk.

17. The method of claim 16, further comprising treating the patient with the identified course of preventative treatment and monitoring the patient for the condition.

18. The method of claim 16, wherein the condition is type-2 diabetes.

19. The method of claim 15, wherein the course of preventative treatment is applied to the population.

20. The method of claim 16, wherein the course of preventative treatment is applied to individuals within the population having a determined risk above a threshold.
